(19) United States
(12) Patent Application Publication
(10) Pub. No.: US 2007/0050254 A1
(43) Pub. Date: Mar. 1, 2007

(54) System and method for trading context-specific advertising

(75) Inventor: James R. Driscoll, New York, NY (US)

Correspondence Address: BAKER BOTTS L.L.P., 2001 ROSS AVENUE, SUITE 600, DALLAS, TX, 75201-2980, US

(73) Assignee: eSpeed, Inc.

(21) Appl. No.: 11/214,514

(22) Filed: Aug. 29, 2005

(51) Int. Cl. G06Q 30/00

(52) U.S. Cl. 705/14

(57) ABSTRACT

A method for executing trades involving advertising opportunities includes receiving a first order from a first party that indicates a first advertising context. The method also includes receiving a second order from a second party that indicates a second advertising context and determining that the first order matches the second order based, at least in part, on the first advertising context and the second advertising context. Additionally, the method includes initiating a transaction between the first party and the second party involving a quantity of context-sensitive advertising.

### TECHNICAL FIELD OF THE INVENTION

This invention relates in general to trading systems and, more particularly, to a system and method for trading context-specific advertising.

### BACKGROUND OF THE INVENTION

Developments in information technology in recent years have provided advertisers with powerful tools for directing advertising to potential customers. In particular, the development of various types of context-sensitive advertising allow advertisers to select particular individuals to be presented advertising based on the interests, locations, and/or other characteristics of the user. As a result, advertising has become increasingly effective in matching products and services with potential customers. Furthermore, as businesses have become more sophisticated and effective with marketing their products and services, the significance of advertising to success in many industries has grown substantially.

Traditionally, the value of advertising varied primarily due to many factors that affected the availability and demand for advertising market-wide. However, with the increasing availability of context-sensitive advertising, the market for advertising has become increasingly segmented. As a result, the value of particular advertising opportunities may differ dramatically from advertiser to advertiser. Moreover, with the increasing significance of advertising as a driving force for sales and as a source of revenue for advertising suppliers, fluctuations in the value of advertising may leave both advertisers and those that sell advertising vulnerable to substantial financial risk.

### SUMMARY OF THE INVENTION

In accordance with the present invention, the disadvantages and problems associated with purchasing and selling advertising have been substantially reduced or eliminated. In particular, a system and method are provided for trading context-sensitive advertising in a market and/or auction setting.

In accordance with one embodiment of the present invention, a method for executing trades involving advertising opportunities includes a receiving a first order from a first party that indicates a first advertising context and receiving a second order from a second party that indicates a second advertising context. Additionally, the method includes determining that the first order matches the second order based on the first advertising context and the second advertising context. The method also includes initiating a transaction between the first party and the second party involving a quantity of context-sensitive advertising.

In accordance with another embodiment of the present invention, a trading system includes a plurality of trading interfaces and a trading platform. The trading interfaces are each capable of transmitting orders to a trading platform. Each of the orders indicates an advertising context. The trading platform is capable of receiving a first order from a first trading interface that indicates a first advertising context and receiving a second order from a second trading interface that indicates a second advertising context. The trading platform is also capable of determining that the first order matches the second order based on the first advertising context and the second advertising context and initiating a transaction between a first party associated with the first trading interface and a second party associated with the second trading interface involving a quantity of context-sensitive advertising.

Furthermore, the trading platform is capable of receiving a first order from a first trading interface that indicates a first advertising context and of receiving a second order from a second trading interface that indicates a second advertising context. The trading platform is also capable of determining that the first order matches the second order based on the first advertising context and the second advertising context. The trading platform is further capable of initiating a transaction between a first party associated with the first trading interface and a second party associated with the second trading interface involving a quantity of context-sensitive advertising.

Technical advantages of certain embodiments of the present invention include providing an effective technique for exchanging context-sensitive advertising between parties. By providing a market and/or auction environment for exchanging context-sensitive advertising opportunities, certain embodiments of the present invention allow for more efficient use of advertising capacity. Other technical advantages of certain embodiments include the ability to provide advertisers and advertising-providers the ability to hedge against future fluctuations in the price of context-sensitive advertising. Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 is a block diagram illustrating a trading system capable of executing orders involving context-sensitive advertising;

FIG. 2 is a block diagram illustrating the contents of a trading platform that may be utilized in particular embodiments of the trading system;

FIG. 3 is a flowchart detailing an example operation of a particular embodiment of the trading system in completing an example transaction; and

FIG. 4 is a flowchart detailing another example operation of a particular embodiment of the trading system in completing another example transaction.

### DETAILED DESCRIPTION OF THE INVENTION

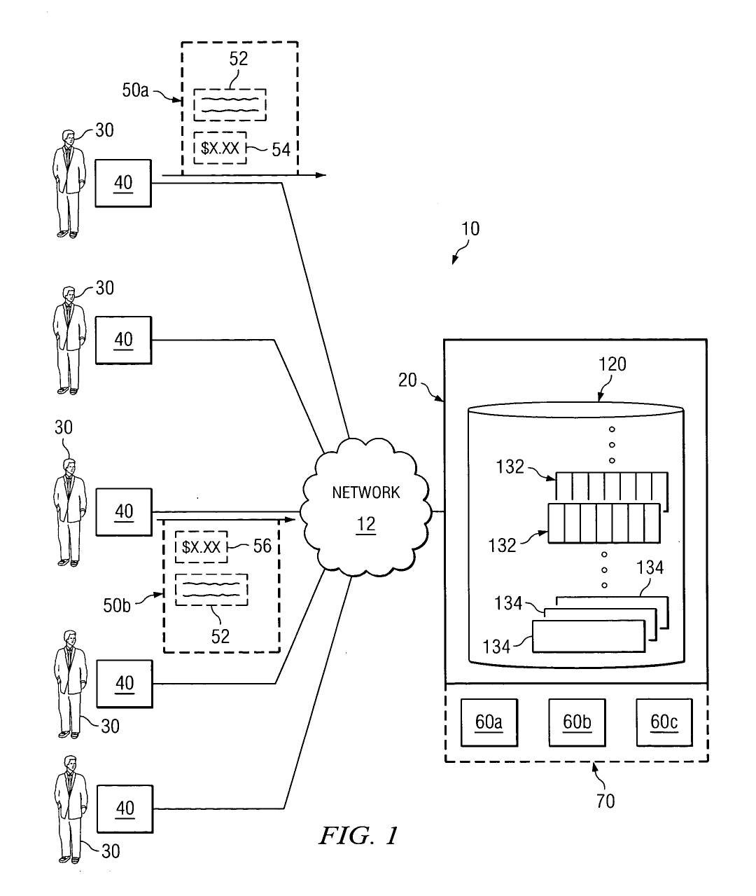

FIG. 1 illustrates a trading system 10 according to a particular embodiment of the present invention. Trading system 10 facilitates the exchange of context-sensitive advertising between advertising providers, advertises, and/or other speculating parties. In particular, the illustrated embodiment of trading system 10 includes a trading platform 20 capable of receiving sale orders 50a and purchase orders 50b from participants 30 through trading interfaces 40. Trading platform 20 is also capable of initiating transactions between participants 30 in advertising market 70 based on these orders 50. By supporting one or more techniques for advertisers to acquire context-sensitive advertising opportunities from advertising providers, particular embodiments of trading system 10 may provide for more efficient distribution of advertising opportunities between participants 30 in advertising market 70. Although the description below focuses on particular embodiments of trading system 10 that include particular elements configured in a particular manner, the present invention contemplates any trading systems capable of providing the described functionality using any appropriate elements configured in any suitable manner.

For the purposes of this description and the claims that follow, context-sensitive advertising may, in general, represent any form of advertising that is displayed, transmitted, played, and/or otherwise communicated to one or more parties based on interests, locations, and/or criteria associated with the parties to whom the advertising is communicated (referred to here as “viewers” of the advertising) and/or based on the circumstance under which the advertising will be communicated to these viewers. As described in greater detail below, examples of context-specific advertising may include, but are not limited to, advertising provided specifically to viewers requesting searches using particular search terms, advertising communicated to viewers requesting content from content-providers of a particular type of content, advertising communicated to viewers who satisfy certain viewer criteria, advertising provided to users requesting information associated with particular locations, and advertising provided to users based on their current location.

Participants 30 purchase and/or sell advertising instruments 60 in advertising markets 70. Participants 30 may represent any suitable advertising consumers, advertising providers, advertising brokers, and/or advertising speculators, and/or brokerages, trading firms, or any other entities suitable to buy and sell advertising instruments 60 for the benefit of participants 30 or other third-party entities. FIG. 1, for the purposes of illustration, provides a number of example participants 30 that may operate in particular embodiments of trading system 10. Examples of participants 30 may include, but are not limited to, small business operators, corporate entities, advertising speculators, internet service providers (ISPs), search engine operators, a web portal operators, news provider, and sports-content providers.

Advertising instruments 60 comprise tradable instruments conveying any appropriate form of right, title, and/or interest in context-sensitive advertising opportunities. As indicated above, context-sensitive advertising may, in general, include any form of advertising that is displayed, transmitted, played, and/or otherwise communicated to one or more viewers based on interests, locations, and/or other characteristics, criteria, or circumstances associated with the relevant viewers. Advertising instruments 60 convey any appropriate form of right, title, and/or interest in any suitable type of context-sensitive advertising. Furthermore, a participant 30 owning a particular advertising instrument 60 may exercise the right conveyed by that advertising instrument 60 in accordance with any appropriate terms associated with advertising instrument 60 or may instead resell the advertising instrument 60 in advertising market 70. As a result, advertising instrument 60 may provide a transferable interest in some form of context-sensitive advertising.

As one example, an advertising instrument 60 may represent a contract or other form of commitment obligating an issuer or seller of advertising instrument 60 to provide a quantity of context-sensitive advertising in accordance with particular terms. Moreover, each unit of advertising instrument 60 may entitle the owner to rights in a single unit of context-sensitive advertising or some predetermined number of units of context-sensitive advertising, based on the terms of advertising instrument 60 and/or the configuration of the relevant advertising market 70. For the purposes of this description and the claims that follow, quantities of context-sensitive advertising may be measured in terms of the number of appropriate individuals to whom the advertising is communicated, the number of times the advertising will be display or communicated to appropriate individuals, the total amount of time the advertising will be displayed or played to appropriate individuals, and/or any other appropriate units for quantifying the amount of advertising provided. In particular embodiments, a participant 30 owning such an advertising instrument 60 may exercise the rights conveyed by that advertising instrument 60 by requesting the issuer or seller communicate advertising provided or specified by the exercising participant 30 in accordance with the quantity and other terms associated with advertising instrument 60.

As another example, an advertising instrument 60 may represent a futures contract that obligates a participant 30 owning the futures contract to purchase, and the seller or issuer of the futures contract to sell, a particular quantity of other advertising instruments 60 at a particular price. For example, in particular embodiments, such a futures contract may be associated with an underlying advertising instrument 60, a settlement date, and a contract price. The futures contract may obligate the participant 30 purchasing the futures contract and the seller or issuer of the futures contract to trade a quantity of the underlying advertising instrument 60 at the contract price on the settlement date.

As yet another example, an advertising instrument 60 may represent an option contract that preserves for the participant 30 owning the option contract the option to purchase or sell a quantity of certain other advertising instruments 60 at a particular option price according to any suitable terms associated with the option contract. In particular embodiments, such an option contract may be associated with an underlying advertising instrument 60, an exercise date, and an exercise price. The option contract may then provide the owning participant 30 with the option to purchase or sell, at the exercise price, a quantity of the relevant underlying advertising instrument 60 on the exercise date.

Moreover, advertising instruments 60 may provide an interest in any suitable form of context-sensitive advertising depending on the type of advertising offered by the issuer of the relevant advertising instrument 60. As one example, advertising instruments 60 may provide their owner an interest in context-sensitive advertising offered by an issuer that operates a networked search engine. As a result, such advertising instruments 60 may provide an interest in a banner ad, a prominently-displayed link, a pop-up window, a recorded audio message, or any other suitable form of advertising that is displayed to viewers requesting searches from the issuer's website that are based on or associated with particular search terms. As another example, advertising instruments 60 may provide their owner an interest in context-sensitive advertising offered by an issuer that operates a mapping website. As a result, such advertising instruments 60 may provide an interest in advertising that is displayed in response to a user of the website requesting information on flights to a destination within a certain distance of a particular location, requesting driving directions that follow a path that comes within a certain distance of a particular location, and/or requesting any other form of information associated with a particular location. As yet another example, advertising instruments 60 may provide their owner an interest in context-sensitive advertising offered by an issuer that provides content of a particular type such as news or sports-related content. As a result, such advertising instruments 60 may provide an interest in an appropriate form of advertising that is displayed to users requesting content from a web server operated by the content provider or requesting content from a particular page hosted by the web server.

Advertising markets 70 represent markets for the trading of advertising instruments 60. Any two of advertising markets 70 may represent a common market, such as a commodity exchange, in which multiple different types of advertising instruments 60 may be traded. For the purposes of this description, advertising markets 70 may include the forum in which particular advertising instruments 60 are traded and/or any appropriate hardware and/or software for facilitating trades of advertising instruments 60 within that forum.

Trading platform 20 receives orders 50 from participants 30 for transactions involving advertising instruments 60 available in advertising market 70 and initiates transactions specified or described by such orders 50. In the illustrated embodiment, trading system 10 includes a single trading platform 20 that is associated with an advertising market 70 in which a particular advertising instrument 60 is traded. For example, in the illustrated embodiment, trading platform 20 represents a server operated by a particular commodities exchange in which advertising instruments 60a-c are traded and trading platform 20 is capable of initiating trades in advertising market 70. Alternative embodiments of trading system 10 may include one or multiple trading platforms 20 each associated with one or more advertising markets 70 in which one or more advertising instruments 60 are traded.

Furthermore, for the purpose of this description and the claims that follow, trading platform 20 may initiate transactions by directly performing the steps necessary to consummate the transaction and/or by communicating with other appropriate elements or entities to facilitate consummation of the transaction. As one example, in particular embodiments, trading platform 20 may maintain accounts for one or more participants 30 and may adjust these accounts in response to orders 50 received from the relevant participants 30. Alternatively, trading platform 20 may initiate a particular transaction by communicating information associated with the relevant orders 50 to other elements of trading system 10 that maintain accounts for participants 30, such as an account server (not explicitly shown) associated with a particular market or markets.

Trading platform 20 may also maintain market information 134 specifying available prices, quantities, and/or other relevant information describing the current state of advertising markets 70. Trading platform 20 may provide this information to participants 30 to be used by these parties in making decisions related to the purchase and sale of advertising instruments 60. In the illustrated embodiment, participants 30 interact with trading platform 20 using trading interfaces 40.

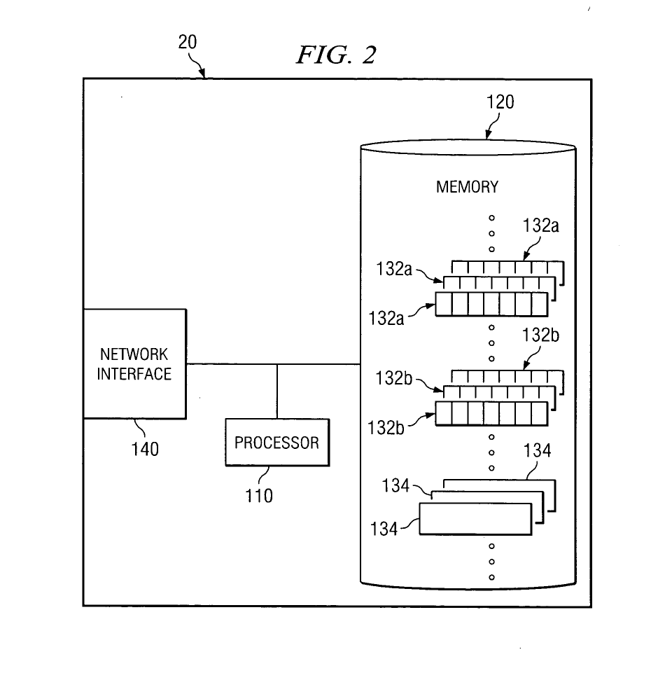

Trading platform 20 may represent any combination of software and/or hardware appropriate to provide the described functionality. As one example, trading platform 20 may represent a server operating in a computer network, such as the Internet, and trading interfaces 40 may represent personal computers (PCs) coupled to this computer network. Under such circumstances, trading platform 20 may be able to receive orders 50 as electronic mail, Hypertext Transfer Protocol (HTTP) requests, and/or any other appropriate form of electronic communication. As another example, trading platform 20 may represent an Automated Call Distributor (ACD) system capable of initiating telephonic communication sessions with participants 30 and receiving orders 50 as part of these telephone communication sessions. Although this description focuses, for the purposes of illustration, on embodiments of trading system 10 in which trading platform 20 represents a single, integrated component, in alternative embodiments, trading platform 20 may represent multiple, distributed components that are physically separated from one another. The contents and operation of an example embodiment of trading platform 20 are described in greater detail below with respect to FIG. 2.

Additionally, although the description below focuses on embodiments of trading system 10 in which trading platform 20 receives orders 50 and automatically executes transactions in response thereto, portions of this process may be performed manually in particular embodiments. For example, a participant 30 may initiate an order 50 by calling an operator associated with trading platform 20 and verbally communicating order 50 to the operator. The operator may then manually enter order 50 into trading platform 20. In general, trading platform 20 may receive, process, and execute purchase orders 50a and sale orders 50b associated with advertising instruments 60 in any appropriate manner based on the capabilities of trading platform 20 and the configuration of trading system 10.

Trading interfaces 40 facilitate interaction between trading platform 20 and participants 30. Trading interfaces 40 receive input from participants 30 associated with orders 50 and transmit orders 50 to trading platform 20 and/or other components of trading system 10 for execution. Additionally, trading interfaces 40 receive market information 134 from trading platform 20 and/or other components associated with advertising market 70, and communicate this information to participants 30. Although FIG. 1 illustrates a particular embodiment of trading system 10 in which particular operations are performed and/or particular functionalities are provided by either participant 30 or trading interface 40, the described operations and functionalities may be divided between participant 30 and trading interface 40 in any appropriate manner. As a result, in particular embodiments, participants 30 may be absent from trading system 10 and fully-automated trading interfaces 40 may instead perform any operations completed by participant 30 in the following description.

In addition, trading interfaces 40 may represent any appropriate combination of hardware and/or software, including multiple, physically-discrete components, to accept and transmit orders 50 placed by participants 30. As one example, trading interfaces 40 may represent personal computers (PCs) capable of receiving market information 134 from trading platform 20 and displaying market information 134 to participants 30. These PCs may also be capable of accepting orders 50 entered by participants 30 and transmitting orders 50 to trading platform 20. Moreover, although shown, for the sake of illustration, in FIG. 1 as coupling to trading platform 20 through network 12, trading interfaces 40 may communicate with trading platform 20, partly or entirely, independently from network 12. Thus, as another example, trading interfaces 40 may represent a television operable to receive and display market information 134 to participants 30 and a telephone through which participants 30 may communicate orders 50 to trading platform 20 or an operator of trading platform 20.

In operation, participants 30 transmit orders 50 to trading platform 20 using trading interfaces 40. Participants 30 may transmit orders 50 to trading platform 20 over network 12 or any other suitable elements connecting trading interfaces 40 and trading platform 20. Trading interfaces 40 may transmit orders 50 to trading platform 20 as electronic mail, as HTTP requests, as part of a telephone conversation, and/or in any other manner appropriate based on the capabilities of trading interfaces 40 and trading platform 20.

Orders 50 describe transactions to be initiated by trading platform 20 involving advertising instruments 60 and may include any appropriate information to describe the transaction requested by the relevant participants 30. For example, in the illustrated embodiment, trading interfaces 40 transmit sale orders 50a requesting the sale of particular quantities of one or more advertising instruments 60. Sale orders 50a include an offer price specifying the price the relevant party would be willing to accept for sale of an associated advertising instrument 60 and may indicate a sale advertising context 116 for the instance or instances of advertising instrument 60 that the participant 30 is offering. Similarly, in the illustrated embodiment, trading interfaces 40 also transmit purchase orders 50b requesting the purchase of particular quantities of one or more advertising instruments 60. Purchase orders 50b may specify particular instances of advertising instrument 60 to be purchased by indicating a purchase advertising context 117 and include a bid price indicating the price the relevant party would like to pay.

In the illustrated embodiment, orders 50 may specify advertising contexts in any appropriate manner based on the type of advertising contexts available in advertising market 70. As indicated, above advertising contexts may indicate any one or more interests, locations, and/or other characteristics, criteria, or considerations associated with the viewers to whom the advertising will be communicated and/or the circumstance under which the advertising is communicated to the appropriate viewers. Thus, as one example, one or more advertising instruments 60 sold in advertising market 70 may be associated with particular search terms. As a result, participant interfaces 40 may generate orders 50 that specify one or more search terms for the advertising instruments 60 to be bought or sold. As another example, one or more advertising instruments 60 may be associated with particular locations, and participant interfaces 40 may generate orders 50 that specify locations associated with the advertising instruments 60 to be bought or sold. As yet another example, one or more advertising instruments 60 may be associated with particular viewer criteria that describe viewers to whom the relevant advertising should be displayed, and participant interfaces 40 may generate orders 50 that specify one or more viewer criteria for advertising instruments 60 to be bought or sold. Additionally, in particular embodiments, advertising instruments 60 may represent futures contracts, option contracts, or other types of instruments that define entitlements and obligations of the involved parties based on some underlying instrument, and such advertising instruments 60 may indicate an advertising context by specifying their underlying advertising instrument or instruments 114. In general, however, trading system 10 may support any suitable types of advertising contexts and, thus, orders 50 may specify any appropriate type of advertising based on the characteristics of the advertising instruments 60 traded in trading system 10.

In the illustrated embodiment, a single type of advertising instrument 60 is traded in advertising market 70 and each instance of advertising instrument 60 is associated with one of several different advertising contexts that are being traded within advertising market 70. In such an embodiment, trading platform 20 may be operable to receive orders 50 that specify one or more of the advertising contexts being traded in advertising market 70. In alternative embodiments, trading platform 20 may be responsible for processing orders 50 for multiple advertising markets 70 involving the trade of multiple different types of advertising instruments 60. For example, trading platform 20 may be responsible for initiating both trades involving a particular advertising instrument 60 and trades involving futures contract and/or options contract having that particular advertising instrument 60 as the underlying instrument. In such embodiments, orders 50 may additionally specify a particular type of advertising instrument 60, such as a contract or option contract, to be bought or sold in conjunction with executing the relevant order 50.

More generally, orders 50 may, depending on the characteristics of advertising instruments 60 traded in advertising market 70, specify any appropriate additional terms to properly identify a specific type of advertising instrument 60 to be involved in the transactions requested by orders 50. For example, a particular advertising instrument 60 may represent an option contract on other advertising instruments 60. Orders 50 that request transactions involving such advertising instruments 60 may define option prices, settlement dates, and/or other terms to be used by trading platform 20 in executing trades based on these orders 50.

After receiving an order 50, trading platform 20 may attempt to identify a corresponding order 50 based, at least in part, on information specified by the relevant orders 50. Depending on the configuration of trading system 10 and/or the advertising market 70 associated with the relevant orders 50, trading platform 102 may match orders 50 in various different manners. In particular embodiments, trading platform 20 may match sale orders 50a and purchase orders 50b based on advertising contexts, transaction prices, option terms, instrument types, and/or any other appropriate information specified by orders 50. Additionally, trading platform 20 may use any appropriate techniques to match orders 50 based on the relevant criteria.

As one example, advertising market 70 may operate as an on-demand market, and trading platform 20 may initiate trades involving a received order 50 if trading platform 20 is able to identify a corresponding order 50 with an advertising context and price that matches the received order 50. For example, trading platform 20 may store received orders 50 in one or more order queues 132 maintained by trading platform 20 until trading platform 20 can match that order 50 to another order 50 received by trading platform 20 and initiate a trade involving the matched orders 50. Thus, when trading platform 20 receives an order 50, trading platform 20 may determine whether any complementary order 50 currently stored in order queues 132 specifies a matching advertising context and a price that is at least as desirable as the price specified by the received order 50. For the purposes of this description and the claims that follow, a first advertising context may match a second advertising context by being identically equal to, being equivalent to, being sufficiently similar to, corresponding to, being related to, and/or having any other appropriate form of association with the second context. Moreover, the first advertising context may also match the second advertising context by describing a generic species of advertising contexts of which the second advertising context is a member or by representing a member of a generic species of advertising contexts described by the second advertising context.

As a result, if trading platform 20 receives a sale order 50a, trading platform may determine whether a purchase order 50b currently stored in an order queue 132 maintained by trading platform 20 has a matching advertising context and a bid price that is at least as high as the offer price specified by the received sale order 50a. If trading platform 20 is able to identify a matching purchase order 50b, trading platform 20 initiates a trade involving the received sale order 50a and the matched purchase order 50b. If trading platform 20 is unable to identify a matching purchase order 50b, trading platform 20 may store the received sale order 50a in an appropriate order queue 132 until a matching purchase order 50b is received by trading platform 20.

Similarly, if trading platform 20 receives a purchase order 50b, trading platform may determine whether a sale order 50a currently stored in an order queue 132 maintained by trading platform 20 has a matching advertising context and an offer price that is as low or lower than the bid price specified by the received purchase order 50b. If trading platform 20 is able to identify a matching sale order 50a, trading platform 20 initiates a trade involving the received purchase order 50b and the matched sale order 50a. If trading platform 20 is unable to identify a matching sale order 50b, trading platform 20 stores the received purchase order 50b in an appropriate order queue 132 until a matching sale order 50a is received by trading platform 20.

As a result, particular embodiments of trading system 10 may facilitate the trading of advertising instruments 60 in a real-time market. In such embodiments, participants 30 may be able to react quickly to changes in their advertising needs or supply. Additionally, participants 30 may also respond rapidly to external factors that affect demand and supply of other participants 30 trading within advertising markets 70. For example, the occurrence of some newsworthy event may cause a sudden increase in interest and, thus, searches relating to the event. This, in turn, may increase the effectiveness of tying advertising to searches.

Furthermore, the existence of a market environment for trading advertising instruments 60 may allow advertising consumers, such as small business operators, corporate entities, and advertising speculators, to specify quantifiable standards for the advertising provided by advertising suppliers, such as ISPs, search engine operators, web portals, news content providers, and/or sports-content providers. Advertisement consumers may agree with advertising suppliers, through the issue and purchase of advertising instruments 60, on a quantity of context-sensitive advertising that the advertising supplier will supply to the consumer. For example, in particular embodiments, each advertising instrument 60 is associated with an obligation to display the purchasers advertising to one viewer. As a result, an advertising consumer may ensure a specific number of context-sensitive viewings by purchasing an equivalent number of advertising instruments 60. Moreover, if the advertising supplier who issued the advertising instruments 60 finds itself unable to fully satisfy its obligation under the terms of the advertising instruments 60, the advertising consumer may insist that the issuing supplier purchase equivalent advertising instruments 60 from other issuers for the same advertising context to complete its obligation. Thus, trading platform 20 and advertising market 70 provide an effective way for advertising consumers to ensure satisfaction of their advertising needs.

As another example of how trading platform 20 may be configured, advertising market 70 may, in particular embodiments, operate as an auction market. Trading platform 20 may receive an initial order 50 establishing an auction and may store this initial order 50 in an appropriate order queue 132. The initial order 50 may define terms for the auction including, for example, starting and ending times for the auction and a starting price for the auction. Trading platform 20 may then store, in an appropriate order queue 132 associated with the relevant auction, subsequently-received orders 50 that specify advertising contexts matching the advertising context and/or other terms specified by the initial order 50. At a subsequent time, such as the ending time specified by the initial order 50, trading platform 20 may determine a winning order 50 of the auction based on the prices specified by the orders 50 stored in the order 50 queue associated with the auction. Trading platform 20 may then initiate a trade between parties associated with the initial order 50 and the winning order 50.

For example, if trading platform 20 receives an initial sale order 50a describing an auction established by a particular participant 30, trading platform 20 may store the initial sale order 50a in an order queue 132 associated with the auction. Trading platform may then store, in the order queue 132 associated with the auction, subsequently-received purchase orders 50 that specify terms matching the advertising context 52 and/or other terms specified by the initial sale order 50a. At an appropriate later point, such as at an auction end time specified by the initial sale order 50a, trading platform 20 identifies a winner of the auction. Because the auction, in this example, is a sale auction, trading platform 20 identifies the purchase order 50b specifying the highest bid price 54. Trading platform may then initiate a trade between parties associated with the initial sale order 50a and the winning purchase order 50b.

Similarly, if trading platform 20 receives an initial purchase order 50b establishing an auction, trading platform 20 may store the initial purchase order 50b in an order queue 132 associated with the auction. Trading platform may then store, in the order queue 132 associated with the auction, subsequently-received sale orders 50a that specify terms matching the advertising context 52 and/or other terms specified by the initial purchase order 50b. At an appropriate later point, such as at an auction end time specified by the initial purchase order 50b, trading platform 20 identifies a winner of the auction. Because the auction, in this example, is a purchase auction, trading platform 20 identifies the sale order 50a specifying the lowest offer price. Trading platform may then initiate a trade between parties associated with the initial purchase order 50b and the winning sale order 50a.

As a result, trading platform 20, in particular embodiments, may be capable of conducting auctions for the sale and/or purchase of advertising instruments 60. Because such auctions may take place over a period of time with several participants 30 offering bids, particular embodiments of trading system 10 may allow a purchaser or seller of advertising instruments 60 to obtain optimal transaction prices even in shallow markets where trading is light. Thus, the auction environment supported by particular embodiments of trading platform 20 may provide additional benefits for participants 30.

Regardless of the particular matching technique utilized by trading platform 20, trading platform 20, after matching a particular order 50a and 50b, may initiate trades involving advertising instruments 60 specified by the matched orders 50. As part of initiating the trades, trading platform 20 may execute any steps appropriate based on the configuration and capabilities of trading platform 20 and/or the characteristics of the relevant advertising instruments 60 and advertising market 70. As noted above, particular embodiments of trading platform 20 maintain trading accounts associated with one or more participants 30. These trading accounts indicate quantities of various advertising instruments 60 owned by the relevant parties and financial resources available to the relevant parties for trading, such as an amount of money deposited in the account. In such embodiments, trading platform 20 may initiate trades specified by orders 50, in part or in whole, by adjusting the trading accounts and/or information stored in or associated with the trading accounts. In particular, trading platform 20 may adjust the share totals and cash balances of the trading accounts associated with the relevant parties to reflect the requested transactions. In particular embodiments, trading platform 20 may initiate trades specified by orders 50 by additionally or alternatively communicating with other components of trading system 10 and/or components external to trading system 10 to complete the relevant trade. For example, in particular embodiments, trading platform 20 may initiate the trade by communicating information describing the trade to other components, within or external to trading system 10, that are responsible for executing the trade.

Additionally, in particular embodiments, trading system 10 may support the resale of advertising instruments 60 to enable participants 30 to dispose of excess advertising instruments 60 previously purchased by those participants 30. For example, trading platform 20 may receive a purchase order 50b specifying a first quantity of a particular advertising instrument 60 and may initiate a purchase for the relevant participant 30 of the quantity of the relevant advertising instrument 60 specified by the purchase order 50b. Trading platform 20 may later receive a sale order 50a from the same participant 30 specifying a second quantity of the same advertising instrument 60 with the second quantity representing all or a portion of the advertising instrument 60 previously purchased by that participant 30. Trading platform 20 may then initiate another transaction involving that advertising instrument 60 between the first participant 30 and a second participant 30 attempting to purchase advertising instruments 60 of the type and context of the relevant advertising instrument 60. The original seller of the advertising instrument 60 may then be obligated to provide advertising associated with the second quantity of advertising instrument 60 to the second participant 30 when the second participant exercises the rights or interests associated with those advertising instruments 60.

Thus, particular embodiments of trading system 10 may provide a number of techniques for trading advertising instruments 60 that provide an efficient mechanism for the purchase and sale of context-sensitive advertising. By matching consumers and suppliers of context-sensitive advertising, trading system 10 may create a liquid market for such advertising that produces prices that more accurately reflect the market factors that impact the value of advertising. Additionally, trading system 10 may provide an effective safety-net for providers attempting to cover unsatisfied advertising obligations to consumers and consumers attempting to dispose of excess advertising. This may allow for more efficient distribution of advertising resources to entities best suited to efficiently utilize these resources.

Furthermore, certain types of advertising instruments 60 that may be traded in particular types of trading systems 10 may allow participants to hedge against future shifts in advertising market 70. In particular, advertising instruments 60 may represent futures contracts and/or option contracts that allow advertising consumers or advertising suppliers to lock in certain prices for specified amounts of context-sensitive advertising. As a result, trading system 10 may reduce the risk to advertising consumers 114 that the price of advertising associated with a particular advertising context will dramatically increase in the future and drive up the advertising consumer's marketing costs. Similarly, trading system 10 may reduce the risk to advertising suppliers that the price will fall significantly reducing the supplier's anticipated revenues. For example, a particular advertising consumer hoping to secure banner ads with a search engine for searches associated with the Super Bowl may be able to protect against the possibility that a popular match-up will dramatically increase prices for such advertising. Similarly, a search engine operator hoping to sell advertising rights to searches associated with the Super Bowl may be able to prevent an unexciting match-up from eroding the operator's anticipated revenue.

In this regard, particular embodiments of trading system 10 may provide multiple operational benefits. Various embodiments of trading system 10, however, may exhibit some, none, or all of the benefits described above. Furthermore, although this description details specific examples of how advertising instruments 60 may be traded within particular embodiments of trading system 10, including in a real-time market and an auction market, particular embodiments of trading system 10 may be configured to trade advertising instruments 60 in any appropriate manner.

FIG. 2 is a block diagram illustrating the contents of a particular embodiment of trading platform 20. As described above, trading platform 20 receives orders 50 and initiates trades involving advertising instruments 60 based on the received orders 50. As shown, trading platform 20 includes a processor 110, a memory 120, and a network interface 140.

Processor 110 is operable to execute instructions associated with the operation trading platform 20 including, in particular embodiments, the matching of orders 50 and the initiation of trades. Processor 110 may represent any suitable device capable of processing and/or communicating electronic information. Examples of processor 110 include, but are not limited to, application-specific integrated circuits (ASICs), field-programmable gate arrays (FPGAs), digital signal processors (DSPs) and any other suitable specific or general purpose processors.

Memory 120 stores processor instructions and/or any other appropriate information used by trading platform 20 in operation. In particular embodiments, trading platform 20 maintains order queues 132. Trading platform 20 may also store, in memory 120b, market information 134, orders 50, and/or any other suitable information used by trading platform 20 during operation. Memory 120 may represent any collection and arrangement of volatile or non-volatile, local or remote devices suitable for storing data such as, for example, random access memory (RAM) devices, read only memory (ROM) devices, magnetic storage devices, optical storage devices, or any other suitable data storage devices.

Order queues 132 store orders 50 received by trading platform 20 until trading platform 20 initiates transactions involving the received orders 50. Order queues 132 may represent all or a portion of memory 120 and/or other appropriate memory devices. Trading platform 20 may include any appropriate number of order queues 132, and orders 50 may be grouped in order queues 132 in any appropriate manner. In the illustrated embodiment, trading platform 20 maintains a plurality of sale order queues 132a and a plurality of purchase order queues 132b. Each sale order queue 132a is associated with a particular advertising context 52 and a particular offer price 54, and trading platform 20 stores received sale orders 50a in the sale order queue 132a associated with the advertising context 52 and offer price 54 indicated by those sale orders 50a. Similarly, each purchase order queue 132b is associate with a particular advertising context 54 and a particular bid price 56, and trading platform 20 stores received purchase orders 50b in the purchase order queue 132b associated with the advertising context 52 and offer price 56 indicated by those purchase orders 50b.

Network interface 140 facilitates interaction between trading platform 20 and network 12 and/or other networks coupled to trading platform 20. In particular embodiments, trading platform 20 may receive orders 50 from participant interfaces 40 through network interface 140. In particular embodiments, trading platform 20 may communicate information to other components through network interface 140 for purposes of initiating trades. Network interface 140 may represent any appropriate combination of hardware and/or software suitable to provide the described functionality.

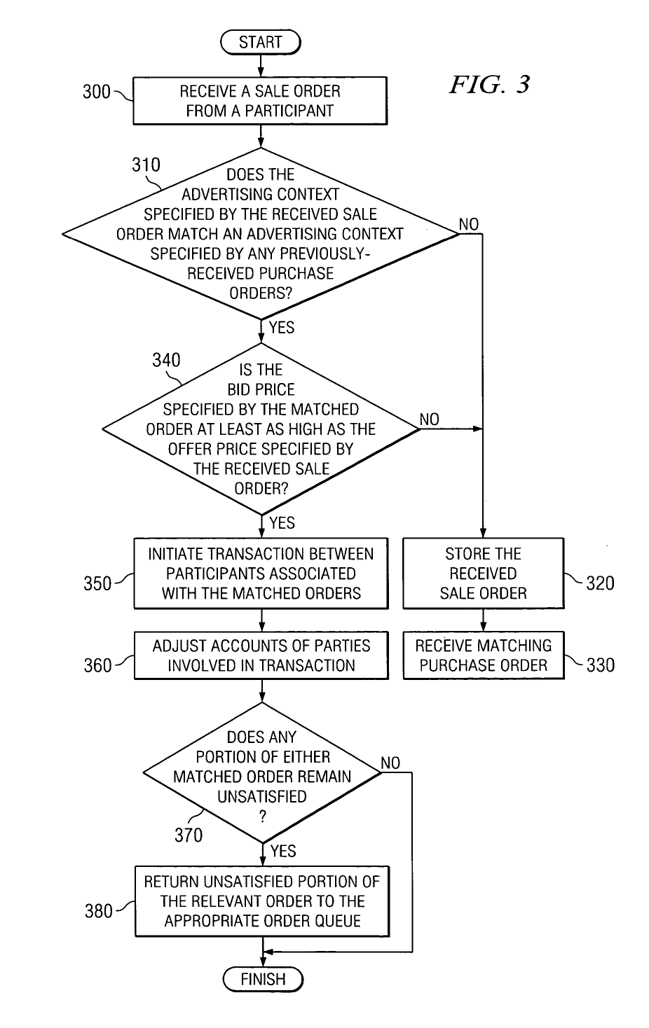

FIG. 3 is a flow chart describing an example operation of trading platform 20 according to a particular embodiment. In particular, FIG. 3 illustrates example operation of trading platform 20 in conducting trades in a real-time market environment. Although FIG. 3 illustrates an example operation performed by a particular embodiment of trading platform 20, any of the steps illustrated in FIG. 3 may be combined, modified or deleted, where appropriate, and additional steps may also be added to the described process. Additionally, steps may be performed in any suitable order without departing from the scope of the invention.

Operation begins at step 300, with trading platform 20 receiving an order 50 from a participant 30 through a participant interface 40. Order 50 indicates one or more terms associated with a transaction requested by the participant 30. In the described example, the received order 50 is assumed to be a sale order 50a. Furthermore, the received order 50a is assumed to specify an advertising context 52 associated with the requested transaction, an offer price 54, and an order quantity indicating an amount of the relevant advertising instrument 60 the participant 30 would like to sell.

At step 310, trading platform 20 determines whether the advertising context 52 specified by the received sale order 50a matches an advertising context 52 specified by any previously-received purchase orders 50b stored in order queues 132. If the advertising context 52 specified by the received sale order 50a does not match any previously-received purchase orders 50b, trading platform 20 stores the received sale order 50a in an appropriate order queue 132, at step 320, until trading platform 20 receives a matching purchase order 50b, which trading platform 20 is assumed to do at step 330. Once trading platform 20 receives the matching purchase order 50b, operation continues at step 350.

If trading platform 20 instead determines that the advertising context 52 specified by the received sale order 50a does match the advertising context 52 specified by one or more previously-received purchase orders 50b, trading platform 20 determines, at step 340, whether the bid price 56 specified by any of the matched purchase orders 50b is at least as high as the offer price 54 specified by the received sale order 50a. If not, trading platform 20 stores the received sale order 50a in an appropriate order queue 132, at step 320, until trading platform 20 receives a matching purchase order 50b. If trading platform 20, determines that one or more of the matching purchase orders 50b specifies a bid price 56 greater than or equal to the offer price 54 specified by the received purchase order 50b, operation continues at step 350.

At step 350, trading platform 20 initiates a transaction between the participant 30 who transmitted the received sale order 50a and the participant 30 who transmitted the matching purchase order 50b. If multiple previously received purchase orders 50b match the terms indicated by the received sale order 50a, trading platform 20 may choose a particular matching purchase order 50b using any appropriate techniques. For example, trading platform 50a may choose the purchase order 50b at the front of a particular order queue 132 that stores purchase orders 50b matching the terms of the received sale order 50a. Trading platform then initiates the transaction between the participant 30 who transmitted the received sale order 50a and the participant 30 who transmitted the selected matching purchase order 50b. In particular embodiments, trading platform 20 may be responsible for maintaining trading accounts for each of participants 30 and may, at step 360, adjust accounts associated with the parties involved in the transaction to reflect the results of the transaction.

Additionally, trading platform 20 determines, at step 370, whether any portion of the transaction quantity specified by the received sale order 50a or the matching purchase order 50b remains unsatisfied following the transaction. If not, operation ends. If a portion of the transaction quantities of one of the orders 50 remains unsatisfied following the transaction, trading platform 20 may return the unsatisfied order 50 to an appropriate order queue 132 at step 380. The unsatisfied order 50 may remain in the order queue 132 until being satisfied by a subsequently-received order 50 that matches the unsatisfied order 50. Operation then ends.

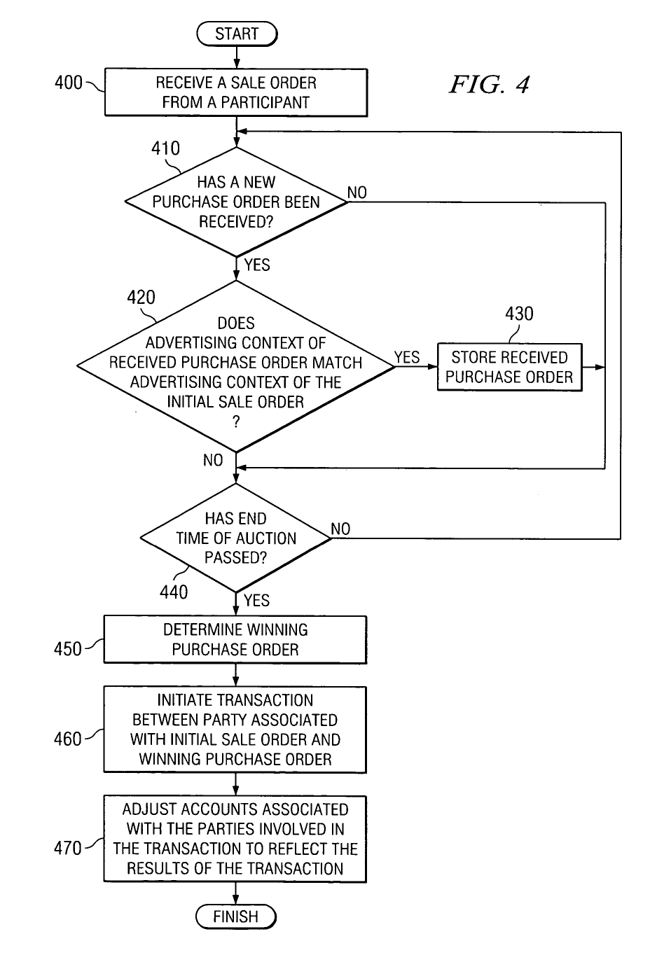

FIG. 4 is a flow chart describing another example operation of trading platform 20 according to a particular embodiment. In particular, FIG. 4 illustrates example operation of trading platform 20 in conducting trades in an auction environment. Although FIG. 4 illustrates an example operation performed by a particular embodiment of trading platform 20, any of the steps illustrated in FIG. 4 may be combined, modified or deleted, where appropriate, and additional steps may also be added to the described process. Additionally, steps may be performed in any suitable order without departing from the scope of the invention.

Operation begins at step 400, with trading platform 20 receiving an order 50 from a participant 30 through a participant interface 40. Order 50 indicates one or more terms associated with a transaction requested by the participant 30. In the described example, the received order 50 is assumed to be a sale order 50a specifying terms for an auction to be run on behalf of the participant 30 who transmitted the received sale order 50a.

At step 410, trading platform 20 determines whether trading platform 20 has received any additional purchase orders 50b from a participant 30. If not, operation continues at step 440. If trading platform has received an additional purchase order 50b, trading platform 20, at step 420, determines whether the advertising context 52 specified by purchase order 50b matches advertising context 52 of the initial sale order 50a. If the advertising context 52 indicated by purchase order 50b matches the advertising context 52 indicated by the initial sale order 50a, trading platform 20 stores the received purchase order 50b in the order queue 132 associated with the auction.

Although not shown as a step in FIG. 4, trading platform 20 may, if the advertising context 52 indicated by purchase order 50b does not match the advertising context 52 indicated by the initial sale order 50a, store the received purchase order 50b in another order queue 132 until trading platform 20 receives a sale order 50a initiating an auction which the received purchase order 50b matches. Alternatively, trading platform 20 may discard the received purchase order 50b in response to determining that it does not match the initial sale order 50a. In general, however, trading platform may, upon determining that the advertising context 52 indicated by the received purchase order 50b does not match the advertising context 52 indicated by the initial sale order 50a, process the received purchase order 50b in any manner appropriate based on the configuration of trading system 10.

At step 440, trading platform determines whether the end time specified for the auction has passed. If not, operation returns to step 410. If the end time for the auction has passed, trading platform 20 determines, at step 450, a winning purchase order 50b. In particular embodiments, trading platform 20 determines the winning purchase order 50b by identifying the matching purchase order 50b that specifies the highest bid price 56. After determining the winning purchase order 50b, trading platform 20 initiates, at step 460, a transaction between the participants who transmitted the initial sale order 50a and the winning purchase order 50b to trading platform 20. In particular embodiments, trading platform 20 may be responsible for maintaining trading accounts for each of participants 30 and may, at step 470, adjust accounts associated with the parties involved in the transaction to reflect the results of the transaction. Operation may then end.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A method for executing trades involving advertising opportunities, comprising:
receiving a first order from a first party that indicates a first advertising context;
receiving a second order from a second party that indicates a second advertising context;
determining that the first order matches the second order based, at least in part, on the first advertising context and the second advertising context; and
initiating a transaction between the first party and the second party involving a quantity of context-sensitive advertising.

2. The method of claim 1, wherein:
receiving the first order from a first party comprises receiving a plurality of purchase orders from a plurality of buyers that each indicate a purchase advertising context and a purchase price;
receiving the second order comprises receiving a sale order from a seller that indicates a sale advertising context;
determining that the first order matches the second order comprises:
determining that one or more of the purchase orders matches the sale order based on the purchase advertising context indicated by the matching purchase orders and the sale advertising context; and
identifying the matching purchase order that indicates a greatest purchase price; and
initiating a transaction between the first party and the second party comprises initiating a transaction involving a quantity of context-sensitive advertising between the seller and a buyer from whom the matching purchase order that indicates the greatest purchase price was received.

3. The method of claim 1, wherein:
receiving the first order from a first party comprises receiving a plurality of sale orders from a plurality of sellers that each indicate a sale advertising context and a sale price;
receiving the second order comprises receiving a purchase order from a buyer that indicates a purchase advertising context;
determining that the first order matches the second order comprises:
determining that one or more of the sale orders matches the purchase order based on the sale advertising context indicated by the matching sale orders and the purchase advertising context; and
identifying the matching sale order indicating that indicates a lowest sale price; and
initiating a transaction between the first party and the second party comprises initiating a transaction involving a quantity of context-sensitive advertising between the buyer and the seller from whom the matching sale order that indicates the lowest sale price was received.

4. The method of claim 1, wherein:
the first order comprises a purchase order that includes a purchase price;
the second order comprises a sale order that includes a sale price; and
determining that the first order matches the second order comprises:
determining that the first advertising context matches the second advertising context; and
determining that the purchase price is equal to the sale price.

5. The method of claim 1, wherein initiating the transaction between the first party and the second party comprises initiating a sale of an advertising futures contract between the first party and the second party, wherein the advertising futures contract specifies a time period and wherein the futures contract obligates the second party to provide a predetermined quantity of context-sensitive advertising to the first party during the specified time period.

6. The method of claim 1, wherein initiating the transaction between the first party and the second party comprises initiating a sale between the first party and the second party of an option contract associated with context-sensitive advertising.

7. The method of claim 6, wherein the option contract indicates an exercise date, an exercise price, and a settlement date and provides the first party an option to, on the exercise date, purchase at the exercise price a predetermined quantity of context-sensitive advertising to be provided before the settlement date.

8. The method of claim 6, wherein the option contract indicates an exercise date, an exercise price, and a settlement date and provides the first party an option to, on the exercise date, sell at the exercise price a predetermined quantity of context-sensitive advertising to be provided before the settlement date.

9. The method of claim 1, wherein:
receiving the first order from the first party that indicates the first advertising context comprises receiving a first order from the first party that specifies one or more search terms; and
initiating a transaction between the first party and the second party involving a quantity of context-sensitive advertising comprises initiating a transaction between the first party and the second party involving the display of advertising to users that request searches associated with the specified search terms.

10. The method of claim 1, wherein:
receiving the first order from the first party that indicates the first advertising context comprises receiving a first order from the first party that specifies a content type; and
initiating a transaction between the first party and the second party involving a quantity of context-sensitive advertising comprises initiating a transaction between the first party and the second party involving the display of advertising to users that request content from providers that provide content of the content type specified by the first order.

11. The method of claim 1, wherein:
receiving the first order from the first party that indicates the first advertising context comprises receiving a first order from the first party that specifies an advertising location; and
initiating a transaction between the first party and the second party involving a quantity of context-sensitive advertising comprises initiating a transaction between the first party and the second party involving the display of advertising to users requesting information associated with locations located within a predetermined distance from the advertising location.

12. The method of claim 1, wherein:
receiving the first order comprises receiving an order that specifies one or more viewer criteria; and
initiating a transaction between the first party and the second party comprises initiating a transaction between the first party and the second party involving the display of advertising to users that satisfy the viewer criteria.

13. The method of claim 1, wherein initiating a transaction between the first party and the second party comprises initiating a first transaction between the first party and the second party that obligates the second party to provide a first quantity of context-sensitive advertising for the first party, and further comprising initiating a second transaction between the second party and a third party that obligates the third party to provide a second quantity of context-sensitive advertising for the first party, wherein the second quantity comprises at least a portion of the first quantity.

14. The method of claim 1, wherein initiating a transaction between the first party and the second party comprises initiating a first transaction between the first party and the second party that obligates the first party to provide a first quantity of context-sensitive advertising for the second party, and further comprising initiating a second transaction between the second party and a third party that obligates the first party to provide a second quantity of context-sensitive advertising for the third party, wherein the second quantity comprises at least a portion of the first quantity.

15. A trading system, comprising:
a plurality of trading interfaces each operable to transmit orders to a trading platform, wherein each order indicates an advertising context; and
a trading platform operable to:
receive a first order from a first trading interface that indicates a first advertising context;
receive a second order from a second trading interface that indicates a second advertising context;
determine that the first order matches the second order based on the first advertising context and the second advertising context; and
initiate a transaction between a first party associated with the first trading interface and a second party associated with the second trading interface involving a quantity of context-sensitive advertising.

16. The system of claim 15, wherein the trading platform is operable to:
receive the first order from the first trading interface by receiving a plurality of purchase orders from a plurality of trading interfaces each associated with a buyer, wherein the purchase orders each indicate a purchase advertising context and a purchase price;
receive the second order by receiving a sale order from a trading interface associated with a seller, wherein the sale order indicates a sale advertising context;
determine that the first order matches the second order by:
determining that one or more of the purchase orders matches the sale order based on the purchase advertising context indicated by the matching purchase orders and the sale advertising context; and
identifying the matching purchase order that indicates a greatest purchase price; and
initiating a transaction between the first party and the second party by initiating a transaction involving a quantity of context-sensitive advertising between the seller and a buyer associated with the trading interface from which the matching purchase order that indicates the greatest purchase price was received.

17. The system of claim 15, wherein the trading platform is operable to:
receive the first order from the first trading interface by receiving a plurality of sale orders from a plurality of trading interfaces, each of the trading interfaces associated with a seller; wherein each of the sale orders indicates a sale advertising context and a sale price;
receive the second order by receiving a purchase order from a trading interface associated with a buyer, wherein the purchase order indicates a purchase advertising context;
determine that the first order matches the second order by:
determining that one or more of the sale orders matches the purchase order based on the sale advertising context indicated by the matching sale orders and the purchase advertising context; and
identifying the matching sale order that indicates a lowest sale price; and
initiating a transaction between the first party and the second party by initiating a transaction involving a quantity of context-sensitive advertising between the buyer and the seller associated with the trading interface from which the matching sale order that indicates the lowest sale price was received.

18. The system of claim 15, wherein:
the first order comprises a purchase order that includes the first advertising context and a purchase price;
the second order comprises a sale order that includes the second advertising context and a sale price; and
the trading platform is operable to determine that the first order matches the second order by:
determining that the first advertising context matches the second advertising context; and
determining that the purchase price is equal to the sale price.

19. The system of claim 15, wherein the trading platform is operable to initiate the transaction between the first party and the second party by initiating a sale of an advertising futures contract between the first party and the second party, wherein the advertising futures contract specifies a time period and wherein the futures contract obligates the second party to provide a predetermined quantity of context-sensitive advertising to the first party during the specified time period.

20. The system of claim 15, wherein the trading platform is operable to initiate the transaction between the first party and the second party by initiating a sale between the first party and the second party of an option contract associated with context-sensitive advertising.

21. The system of claim 20, wherein the option contract indicates an exercise date, an exercise price, and a settlement date and provides the first party an option to, on the exercise date, purchase at the exercise price a predetermined quantity of context-sensitive advertising to be provided before the settlement date.

22. The system of claim 20, wherein the option contract indicates an exercise date, an exercise price, and a settlement date and provides the first party an option to, on the exercise date, sell at the exercise price a predetermined quantity of context-sensitive advertising to be provided before the settlement date.

23. The system of claim 15, wherein the trading platform is operable to:
receive the first order from the first trading interface that indicates the first advertising context by receiving a first order from the first trading interface that specifies one or more search terms; and
initiate a transaction between the first party and the second party involving a quantity of context-sensitive advertising by initiating a transaction between the first party and the second party involving the display of advertising to users that request searches associated with the specified search terms.

24. The system of claim 15, wherein the trading platform is operable to:
receive the first order from the first party that indicates the first advertising context by receiving a first order from the first party that specifies a content type; and
initiate a transaction between the first party and the second party involving a quantity of context-sensitive advertising by initiating a transaction between the first party and the second party involving the display of advertising to users that request content from providers that provide content of the content type specified by the first order.

25. The system of claim 15, wherein the trading platform is operable to:
receive the first order from the first party that indicates the first advertising context by receiving a first order that specifies an advertising location; and
initiate a transaction between the first party and the second party involving a quantity of context-sensitive advertising by initiating a transaction between the first party and the second party involving the display of advertising to users requesting information associated with locations located within a predetermined distance from the advertising location.

26. The system of claim 15, wherein the trading platform is operable to:
receive the first order from the first party that indicates the first advertising context by receiving a first that specifies one or more viewer criteria; and
initiate a transaction between the first party and the second party by initiating a transaction between the first party and the second party involving the display of advertising to users that satisfy the viewer criteria.

27. The system of claim 15, wherein the trading platform is operable to initiate a transaction between the first party and the second party by initiating a first transaction between the first party and the second party that obligates the second party to provide a first quantity of context-sensitive advertising for the first party, and wherein the trading platform is further operable to initiate a second transaction between the second party and a third party that obligates the third party to provide a second quantity of context-sensitive advertising for the first party, wherein the second quantity comprises at least a portion of the first quantity.

28. The system of claim 15, wherein the trading platform is operable to initiate a transaction between the first party and the second party by initiating a first transaction between the first party and the second party that obligates the first party to provide a first quantity of context-sensitive advertising for the second party, and wherein the trading platform is further operable to initiate a second transaction between the second party and a third party that obligates the first party to provide a second quantity of context-sensitive advertising for the third party, wherein the second quantity comprises at least a portion of the first quantity.

29. A device for initiating transaction between parties, comprising:
a memory operable to store processor instructions; and
a processor operable to:
receive a first order from a first party that indicates a first advertising context;
receive a second order from a second trading party that indicates a second advertising context;
determine that the first order matches the second order based on the first advertising context and the second advertising context; and
initiate a transaction between the first party and the second party involving a quantity of context-sensitive advertising.

30. The device of claim 29, wherein the trading platform is operable to:
receive the first order from the first trading interface by receiving a plurality of purchase orders from a plurality of trading interfaces each associated with a buyer, wherein the purchase orders each indicate a purchase advertising context and a purchase price;
receive the second order by receiving a sale order from a trading interface associated with a seller, wherein the sale order indicates a sale advertising context;
determine that the first order matches the second order by:
determining that one or more of the purchase orders matches the sale order based on the purchase advertising context indicated by the matching purchase orders and the sale advertising context; and
identifying the matching purchase order that indicates a greatest purchase price; and
initiating a transaction between the first party and the second party by initiating a transaction involving a quantity of context-sensitive advertising between the seller and a buyer associated with the trading interface from which the matching purchase order that indicates the greatest purchase price was received.

31. The device of claim 29, wherein the trading platform is operable to:
receive the first order from the first trading interface by receiving a plurality of sale orders from a plurality of trading interfaces, each of the trading interfaces associated with a seller; wherein each of the sale orders indicates a sale advertising context and a sale price;
receive the second order by receiving a purchase order from a trading interface associated with a buyer, wherein the purchase order indicates a purchase advertising context;
determine that the first order matches the second order by:
determining that one or more of the sale orders matches the purchase order based on the sale advertising context indicated by the matching sale orders and the purchase advertising context; and
identifying the matching sale order that indicates a lowest sale price; and
initiating a transaction between the first party and the second party by initiating a transaction involving a quantity of context-sensitive advertising between the buyer and the seller associated with the trading interface from which the matching sale order that indicates the lowest sale price was received.

32. The device of claim 29, wherein:
the first order comprises a purchase order that includes the first advertising context and a purchase price;
the second order comprises a sale order that includes the second advertising context and a sale price; and
the trading platform is operable to determine that the first order matches the second order by:
determining that the first advertising context matches the second advertising context; and
determining that the purchase price is equal to the sale price.

33. The device of claim 29, wherein the trading platform is operable to initiate the transaction between the first party and the second party by initiating a sale of an advertising futures contract between the first party and the second party, wherein the advertising futures contract specifies a time period and wherein the futures contract obligates the second party to provide a predetermined quantity of context-sensitive advertising to the first party during the specified time period.

34. The device of claim 29, wherein the trading platform is operable to initiate the transaction between the first party and the second party by initiating a sale between the first party and the second party of an option contract associated with context-sensitive advertising.

35. The device of claim 34, wherein the option contract indicates an exercise date, an exercise price, and a settlement date and provides the first party an option to, on the exercise date, purchase at the exercise price a predetermined quantity of context-sensitive advertising to be provided before the settlement date.

36. The device of claim 34, wherein the option contract indicates an exercise date, an exercise price, and a settlement date and provides the first party an option to, on the exercise date, sell at the exercise price a predetermined quantity of context-sensitive advertising to be provided before the settlement date.

37. The device of claim 29, wherein the trading platform is operable to:
receive the first order from the first trading interface that indicates the first advertising context by receiving a first order from the first trading interface that specifies one or more search terms; and
initiate a transaction between the first party and the second party involving a quantity of context-sensitive advertising by initiating a transaction between the first party and the second party involving the display of advertising to users that request searches associated with the specified search terms.

38. The device of claim 29, wherein the trading platform is operable to:
receive the first order from the first party that indicates the first advertising context by receiving a first order from the first party that specifies a content type; and
initiate a transaction between the first party and the second party involving a quantity of context-sensitive advertising by initiating a transaction between the first party and the second party involving the display of advertising to users that request content from providers that provide content of the content type specified by the first order.

39. The device of claim 29, wherein the trading platform is operable to:
receive the first order from the first party that indicates the first advertising context by receiving a first order that specifies an advertising location; and
initiate a transaction between the first party and the second party involving a quantity of context-sensitive advertising by initiating a transaction between the first party and the second party involving the display of advertising to users requesting information associated with locations located within a predetermined distance from the advertising location.

40. The device of claim 29, wherein the trading platform is operable to:
receive the first order from the first party that indicates the first advertising context by receiving a first that specifies one or more viewer criteria; and
initiate a transaction between the first party and the second party by initiating a transaction between the first party and the second party involving the display of advertising to users that satisfy the viewer criteria.

41. The device of claim 29, wherein the trading platform is operable to initiate a transaction between the first party and the second party by initiating a first transaction between the first party and the second party that obligates the second party to provide a first quantity of context-sensitive advertising for the first party, and wherein the trading platform is further operable to initiate a second transaction between the second party and a third party that obligates the third party to provide a second quantity of context-sensitive advertising for the first party, wherein the second quantity comprises at least a portion of the first quantity.

42. The device of claim 29, wherein the trading platform is operable to initiate a transaction between the first party and the second party by initiating a first transaction between the first party and the second party that obligates the first party to provide a first quantity of context-sensitive advertising for the second party, and wherein the trading platform is further operable to initiate a second transaction between the second party and a third party that obligates the first party to provide a second quantity of context-sensitive advertising for the third party, wherein the second quantity comprises at least a portion of the first quantity.

43. A futures trading system, comprising:
a trading platform operable to:
receive, from a first party, a first request to perform a selected one of a buying and a selling operation involving an advertising instrument that is associated with an advertising context;
receive, from a second party, a second request to perform a selected one of a buying and a selling operation involving the advertising instrument; and
initiate a transaction between the first party and the second party involving the advertising instrument.
